(19) United States
(12) Patent Application Publication
(10) Pub. No.: US 2022/0142208 A1
(43) Pub. Date: May 12, 2022

(54) SPARKLING WATER MICRONUTRIENT DELIVERY SYSTEM

(71) Applicant: BOSSA NOVA SUPERFRUIT COMPANY, Santa Monica, CA (US)

(72) Inventors: Alton Johnson, Santa Monica, CA (US); Anthony Zolezzi, Rancho Santa Fe, CA (US)

(73) Assignee: BOSSA NOVA SUPERFRUIT COMPANY, Santa Monica, CA (US)

(21) Appl. No.: 17/525,762

(22) Filed: Nov. 12, 2021

Related U.S. Application Data
(60) Provisional application No. 63/112,865, filed on Nov. 12, 2020.

(51) Int. Cl. A23L 2/52; A23L 2/04

(52) U.S. Cl. CPC A23L 2/52; A23L 33/30; A23L 2/04

(57) ABSTRACT

A micronutrient delivery system and method are disclosed. The micronutrient delivery system includes two or more beverages where each of the two or more beverages include carbonated water and nutraceuticals from one or more fruits or plants contained in the carbonated water. The two or more beverages contain different amounts of nutraceuticals.

### CROSS REFERENCE TO PRIOR APPLICATION

This application claims the benefit of U.S. Provisional Patent Application No. 63/112,865, entitled as “SPARKLING WATER MICRONUTRIENT DELIVERY SYSTEM”, filed Nov. 12, 2020, which is incorporated by reference in its entirety.

### FIELD OF THE INVENTION

This disclosure relates to a sparkling water beverage and, more particularly to a carbonated water beverage fluid that incorporates fruit or plant components.

### BACKGROUND

Fruit and plant fluid beverages are consumed for their taste and nutritional value. Fruit and plant fluid beverages contain a wide variety of vitamins, nutrients, and minerals, which all together may be referred to as nutraceuticals. Various nutraceuticals contained within Fruit and plant fluids include, but are not limited to vitamin A, vitamin C, vitamin E, vitamin B6, vitamin B12, calcium, iron, magnesium, manganese, molybdenum, zinc, copper, selenium, potassium, phosphorus, thiamin (B1), caffeine, tannin, alkaloids, theobromine, cyanidin-3-sambubioside, cyanidin-3-glucoside, cyanidin 3-rutinoside, peonidin 3-glucoside, peonidin 3-rutinoside, pelargonidin 3-glucoside, ferulic acid, (+)-catechin, (−)-epicatechin, p-hydroxy benzoic acid, gallic acid, protocatechuic acid, ellagic acid, vanillic acid, p-coumaric acid, protocatechuic acid hexoside, protocatechuic acid, p-hydroxybenzoic acid, syringic acid, hydroxyferuloyl quinic acid, sinapoyl rhamnose, 5-O-caffeoyl quinic acid, p-coumaric acid hexoside, caffeic acid, sinapoyl hexose, orientin, isovitexin, homoorientin, vitexin, luteolin, scoparin, chrysoeriol, taxifolin, rutin, isorhamnetin rutinoside, folate, folic acid, riboflavin, niacin, pantothenic acid, chlorogenic acid, epigallocatechin 3-0-gallate, quercetin, quercitrin, hypperoside, kaempferol, kaemperfeol 3-0-rhamnoside, dihydrokaempferol 3-o-a-rhamnoside, dihydroquercetin 3-o-a-rhamnoside, procyanidin b1, aceronidin, cyanidin, cyandidin-3-o-a-rhamnoside, pelargonidn 3-0-arhamoside, delphinidin, peonidin, neoxanthin, neochrome, violaxanthin, luteoxanthin, lutein, zeaxathin, 5,6,5′,6′,-diepoxy-β-cryptoxanthin, 5,6-epoxy-β-cryptoxanthin, 5,8-epoxy β-cryptoxanthin, zeinoxanthin, β-cryptoxanthin, α-carotene, β-carotene, 5,6,5′,6′, diepoxy-β-carotene, 5,8-epoxy-β-carotene, δ-tocopherol, γ-tocopherol, α-tocopherol, δ-tocotrienol, α-tocotrienol, caffeoylshikimic acid, caffeoyl glucose, caffeoylquinicc acid, feruloylquinic acid, epicatechin gallate, methyl epicatechin gallate, epigallocatechin gallate, 3 methyl epigallocatechin gallate, dicaffeoylshikimic acid, dicaffeoylquinic acid, sinapic acid, myricetin, and apigenin.

Fruits and plants also contain various other compounds such as sugars, proteins, fats, and dietary fiber that, while not unhealthy, individuals may prefer to avoid in large amounts. Current fruit and plant-based beverages may have limited nutrients that do not reflect the wide variety of nutrients, minerals, and vitamins found in various fruits and plants. Other current fruit and plant beverages may contribute significant calories from high-calorie compounds including sugars. There is a need for a beverage composition that includes selections and/or subsets of nutraceuticals that are preferred by individuals. There is a further need for a beverage fluid that provides healthy nutritional value from nutraceutical combinations found in fruits and plants without the sugars, fats, and other compounds that individuals may want to avoid in large amounts. There is a further need for a nutrient delivery system that is configured to accommodate the different needs of the individual throughout a daily period.

### SUMMARY

The disclosed invention is a composition for a beverage for human consumption. An exemplary embodiment is a micronutrient delivery system. The micronutrient delivery system includes two or more beverages. Each of the two or more beverages include carbonated water and nutraceuticals from one or more fruits or plants contained in the carbonated water. The two or more beverages contain different amounts of nutraceuticals. The two or more beverages may be configured to be ingested in a specific order. The two or more beverages may include three beverages. The three beverages may be configured to be ingested in 4 hour intervals. A first beverage may include nutraceuticals selected from a group consisting of acai and cherries. A second beverage may include nutraceuticals selected from a group consisting of yerba mate and dragon fruit. A third beverage may include nutraceuticals selected from a group consisting of hops and grapes.

Another general aspect is a beverage system. The beverage system includes two or more beverages where each of the two or more beverages include carbonated water and nutraceuticals from one or more fruits or plants contained in the carbonated water where the two or more beverages contain different amounts of nutraceuticals. A total volume of carbonated water of the two or more beverages may be sufficient to hydrate an individual over the course of a day. Each of the two or more beverages may include instructions to ingest at a different time of day. The two or more beverages may include three beverages. The three beverages may include instructions to be ingested at 4-hour intervals relative to one another. A first beverage may include instructions to be ingested at a time of about 10:00 and nutraceuticals selected from a group consisting of acai and cherries. A second beverage may include instructions to be ingested at a time of about 14:00 and nutraceuticals selected from a group consisting of yerba mate and dragon fruit. A third beverage may include instructions to be ingested at a time of about 18:00 and nutraceuticals selected from a group consisting of hops and grapes.

An exemplary embodiment is a method for delivering micronutrients to an individual. The method includes transferring two or more beverages to the individual where each of the two or more beverages include carbonated water and nutraceuticals from one or more fruits or plants contained in the carbonated water. The two or more beverages contain different amounts of nutraceuticals. The method may further include instructing the individual to ingest each of the two or more beverages at a different time of day. The instructing may include instructions to ingest the two or more beverages in 4-hour intervals. A first beverage may include nutraceuticals selected from a group consisting of acai and cherries. A second beverage may include nutraceuticals selected from a group consisting of yerba mate and dragon fruit. A third beverage may include nutraceuticals selected from a group consisting of hops and grapes. A carbonated water volume of each of the beverages may be determined based on a hydration need of the individual.

In an exemplary embodiment, the beverage includes carbonated water and nutraceuticals from one or more fruits or plants contained in the carbonated water where the beverage contains a concentration between about 1 g/12 oz and about 2 g/12 oz of sugars from the one or more fruits or plants. The nutraceuticals may be from a fruit or plant selected from a group consisting of: açai, acerola, dragon fruit, yerba mate, and gac fruit. The nutraceuticals may be from açai and include calcium, copper, iron, magnesium, manganese, molybdenum, and zinc. The nutraceuticals may include cyanidin-3-sambubuiside, cyanidin-3-glucoside, cyanidin 3-rutinoside, peonidin 3-glucoside, and peonidin 3-rutinoside. The nutraceuticals may include pelargonidin 3-glucoside, ferulic acid, (−)-epicatechin, p-hydroxy benzoic acid, gallic acid, protocatechuic acid, (+)-catechin, ellagic acid, vanillic acid, and p-coumaric acid. The nutraceuticals may include protocatechuic acid hexoside, protocatechuic acid, vanillic acid, syringic acid, hydroxyferuloyl quinic acid, sinapoyl rhamnose, 5-O-caffeoyl quinic acid, p-coumaric acid hexoside, caffeic acid, sinapoyl hexose, orientin, isovitexin, homoorientin, vitexin, luteolin, scoparin, chrysoeriol, taxifolin, rutin, and isorhamnetin rutinoside. The nutraceuticals may be from acerola where the nutraceuticals of the beverage include vitamin A, vitamin C, calcium, and iron. The nutraceuticals may be from acerola where the nutraceuticals in the beverage include magnesium, phosphorus, potassium, sodium, zinc, copper, and selenium. The nutraceuticals may be from acerola where nutraceuticals in the beverage include thiamin, riboflavin, niacin, pantothenic acid, vitamin B6, folate, folic acid, and vitamin E. The nutraceuticals may be from acerola and the beverage may further include gallic acid, syringic acid, p-coumaric acid, ferulic acid, caffeic acid, chlorogenic acid, catechin, epicatechin, quercitrin, hypperoside, rutin, kaempferol, kaemperfeol 3-0-rhamnoside, luteolin, dihydrokaempferol 3-o-α-rhamnoside, dihydrokaempferol 3-o-α-rhamnoside, procyanidin b1, aceronidin, cyanidin, cyanidin-3-o-α-rhamnoside, pelargonidin, pelargonidin-3-o-α-rhamnoside, delphinidin, and peonidin. The nutraceuticals may be from acerola and the beverage may further include neoxanthin, neochrome, violaxanthin, lutein, zeoxathin, 5,6,5′,6′-diepoxy-β-cryptoxanthin, 5,6-epoxy-β-cryptoxanthin, 5,8-epoxy β-cryptoxanthin, zeinoxanthin, β-cryptoxanthin, 5,6,5′,6′ diepoxy-β-carotene, 5,8-epoxy-β-carotene, α-carotene, and β-carotene. The nutraceuticals may be from dragon fruit and nutraceuticals in the beverage may include sodium, vitamin A, vitamin C, and iron. The nutraceuticals may be from dragon fruit and nutraceuticals in the beverage may include niacin, magnesium, phosphorus, potassium, and zinc. The nutraceuticals may be from dragon fruit and nutraceuticals in the beverage may include β-crypto xanthin, β- carotene, δ-tocopherol, γ-tocopherol, α-tocopherol, δ-tocotrienol, and α-tocotrienol. The nutraceuticals may be from yerba mate and nutraceuticals in the beverage may include sodium, calcium, potassium, phosphorus, thiamin (B1), caffeine, tannin, alkaloid, and catechin. The nutraceuticals may be from yerba mate and nutraceuticals in the beverage may include calcium, iron, copper, zinc magnesium, caffeine, and theobromine. The nutraceuticals may be from yerba mate and the beverage may include caffeic acid, quinic acid, catechin/epicatechin, ceffeoylshikimic acid, caffeoyl glucose, caffeoylquinic acid, feruloylquinic acid, epicatechin gallate, epigallocatechin gallate, 3 methyl epigallocatechin gallate, dicaffeoylshikimic acid, dicaffeoylquinic acid, and rutin. The nutraceuticals may be from gac fruit and nutraceuticals in the beverage may include sodium, calcium, iron, magnesium, phosphorus, potassium, copper, zinc, vitamin E, β-carotene, and lycopene. The nutraceuticals may be from gac fruit and nutraceuticals in the beverage may include β-carotene and lycopene. The nutraceuticals may be from gac fruit and nutraceuticals in the beverage may include gallic acid, protocatechuic acid, p-hydroxybenzoic acid, chlorogenic acid, caffic acid, syringic acid, p-coumaric acid, ferulic acid, sinapic acid, rutin, myricetin, luteolin, quercetin, and apigenin.

Another aspect is a method of producing a beverage fluid. The method includes separating a subset of components of a plant or fruit from the plant or fruit and extracting a juice from the subset of components. The method includes reducing a sugar concentration of the juice. The subset of components may include at least one of a pulp or lipids of the plant or fruit. The subset of components may include both the pulp and the lipids of the plant or fruit. The subset of components may be from açai. A reduced sugar concentration of the juice may be between about 1 g/12 oz and about 2 g/12 oz.

### BRIEF DESCRIPTION OF THE DRAWINGS

FIG. 1 is a flow diagram of an embodiment for a process of delivering micronutrients to an individual.

FIG. 2A is an illustration of acai berries that may be incorporated into one or more beverages of the micronutrient delivery system.

FIG. 2B is an illustration of cherries that may be incorporated into one or more beverages of the micronutrient delivery system.

FIG. 2C is an illustration of yerba mate that may be incorporated into one or more beverages of the micronutrient delivery system.

FIG. 2D is an illustration of dragon fruit that may be incorporated into one or more beverages of the micronutrient delivery system.

FIG. 2E is an illustration of hops that may be incorporated into one or more beverages of the micronutrient delivery system.

FIG. 2F is an illustration of grapes that may be incorporated into one or more beverages of the micronutrient delivery system.

FIG. 3 is a schematic of an embodiment of a micronutrient delivery system.

FIG. 4 is an illustration of an embodiment of a bottle that may store a single beverage of the micronutrient delivery system.

FIG. 5A is a graphic illustration of an example of the hydration need of an individual throughout a daily period.

FIG. 5B is a graphic illustration of the number of first beverages, second beverages, and third beverages as they relate to hydration needs of an individual throughout a daily period.

FIG. 6 is a graphic illustration of a bar graph of the number of first beverages, second beverages, and third beverages as they relate to nutritional needs of an individual throughout a daily period.

FIG. 7 is a flow diagram of an embodiment for a process of the disclosed subject matter for producing a beverage fluid.

### DETAILED DESCRIPTION

The disclosed subject matter is a beverage fluid that contains a diverse array of nutrients, minerals, and vitamins (collectively nutraceuticals). The beverage fluid can be enjoyed multiple times a day by an individual without significant caloric impact. Further, the beverage may allow an individual to diversify their intake of whole-food micronutrients, which may boost their immunity, energy levels, etc. Further, the beverage may contain the diverse array of nutrients within carbonated water, which may enhance the taste and/or refreshment for various individuals.

In an exemplary embodiment, the disclosed subject matter contains a subset of nutraceuticals of one or more fruits or plants. For example, the beverage fluid may contain a substantial portion of the nutraceuticals in the açai fruit. And while the beverage fluid, may contain a substantial portion of nutraceuticals, it may lack one or more significant sources of calories in fruits or plants such as sugars, fats, and proteins.

The term sugars used herein refers generally to simple carbohydrates. In various embodiments, the term sugar includes monosaccharides. In one embodiment, sugar includes both monosaccharides and disaccharides. Monosaccharides includes glucose, fructose, and galactose. Disaccharides include sucrose, lactose, and maltose. In yet another embodiment, sugar further includes oligosaccharides. And in an exemplary embodiment, sugar further includes polysaccharides.

In various embodiments, the beverage fluid contains less than about 10% the concentration of sugars of the whole fruit, plant, fruit juice, part of a plant, or plant-based beverage. In various embodiments, the beverage fluid may contain less than about 1%, 5%, 20%, 30%, 40%, or 50% of the concentrations of sugars in a whole fruit, plant, fruit juice, part of a plant, or plant-based beverage. Also, in various embodiments, the beverage fluid may contain none of the sugars contained in a whole fruit, plant, fruit juice, part of a plant, or plant-based beverage. In an exemplary embodiment, the beverage fluid may contain a range of between about 1 g to about 2 g of sugar per 12 oz of the beverage fluid. In various embodiments, the beverage fluid may contain a range of between about 0 g to about 5 g of sugar per 12 oz of the beverage fluid. In various embodiments, the beverage fluid may contain a range of between about 1 g to about 3 g of sugar per 12 oz of the beverage fluid. In various embodiments, the beverage fluid may contain a range of between about 2 g to about 4 g of sugar per 12 oz of the beverage fluid. In various embodiments, the beverage fluid may contain a range of between about 2 g to about 5 g of sugar per 12 oz of the beverage fluid. In various embodiments, the beverage fluid may contain a range of between about 3 g to about 5 g of sugar per 12 oz of the beverage fluid.

In an exemplary embodiment, a subset of nutraceuticals found in a whole fruit or plant may exclude one or more compounds that may be viewed as undesirable. For instance, sugars which can be a significant source of calories in fruit juice, may be excluded from the beverage fluid. The sugars may be excluded in various ways. In one example where each of the nutraceuticals is measured and incorporated into the beverage fluid, the excluded compounds are simply not added to the beverage fluid. In another example where the beverage fluid initially contains the excluded compounds, such as a fruit juice, the excluded compounds may be chemically extracted.

In an exemplary embodiment, the beverage fluid may be prepared by separating the pulp and lipids from an açai fruit and extracting a juice from the separated pulp and lipids. As such the resulting beverage fluid may contain nutraceutical concentrations that differ from the concentrations found in the whole açai fruit. A portion of the sugars in the separated and extracted juice may be removed. In one instance, the separated and extracted juice may have its sugar concentration reduced to a range of between about 1 g/12 oz juice and about 2 g/12 oz juice. In various embodiments, the separated and extracted juice may contain an increased concentration of anthocyanins compared to a concentration of anthocyanins in juice extracted from whole açai fruit. The different concentrations of nutraceuticals in the separated and extracted juice, as compared to the juice of whole açai fruit, offers individuals varied options of nutraceutical combinations in a beverage fluid, which may be beneficial to the health of an individual.

In yet another embodiment, the disclosed subject matter is a beverage system comprising two or more beverages. The two or more beverages may contain the nutraceuticals of different subsets of a fruit or plant. The subsets of nutraceuticals in each of the beverages may be configured to supplement a nutritional need of an individual. In various embodiments, the subsets of nutraceuticals in each of the beverages may be further configured to supplement the nutritional needs of an individual based on the time of day.

For example, a first beverage may contain a subset of nutraceuticals that stimulate immunity in individuals. A second beverage may contain a subset of nutraceuticals that are known to stimulate brain activity in individuals. A third beverage may contain a subset of nutraceuticals that are known to induce calm in individuals.

Instructions may be provided to the individual to direct the individual to ingest the beverages in a specific order. Further, the instructions may direct the individual to ingest the two or more beverages at specific times or during a time period. For instance, the individual may be directed by the instructions to ingest the first beverage in the morning. The instructions may direct the individual to ingest the second beverage in the afternoon. The instructions may then direct the individual to ingest the third beverage in the evening.

The order and timing at which the individual is directed to ingest the two or more beverages may depend on the nutritional needs of the individual throughout a daily period. In an exemplary embodiment, instructions may direct the individual to ingest a beverage containing nutraceuticals that stimulate immunity in the morning. In various embodiments, a specific time such as 10:00 may be provided in the instructions for the individual to ingest the beverage containing nutraceuticals that stimulate immunity.

The carbonated water volume of the two or more beverages may vary depending on the hydration needs of the individual. In various embodiments, multiple first, second, and third beverages may be ingested to properly hydrate the individual. For instance, drinking a single first beverage may be insufficient to hydrate the individual. Instead, the individual may be instructed to ingest two or more first beverages during a morning period to properly hydrate the individual. Likewise, the instructions may direct the individual to ingest two or more second beverages and two or more third beverages based on the individual's hydration needs.

In an exemplary embodiment, the individual may ingest different volumes of the two or more beverages. For instance, the individual may ingest 24 ounces of a first beverage, 48 ounces of a second beverage, and 12 ounces of a third beverage. The individual may be directed to ingest various combinations of volumes based on the hydration needs of the individual.

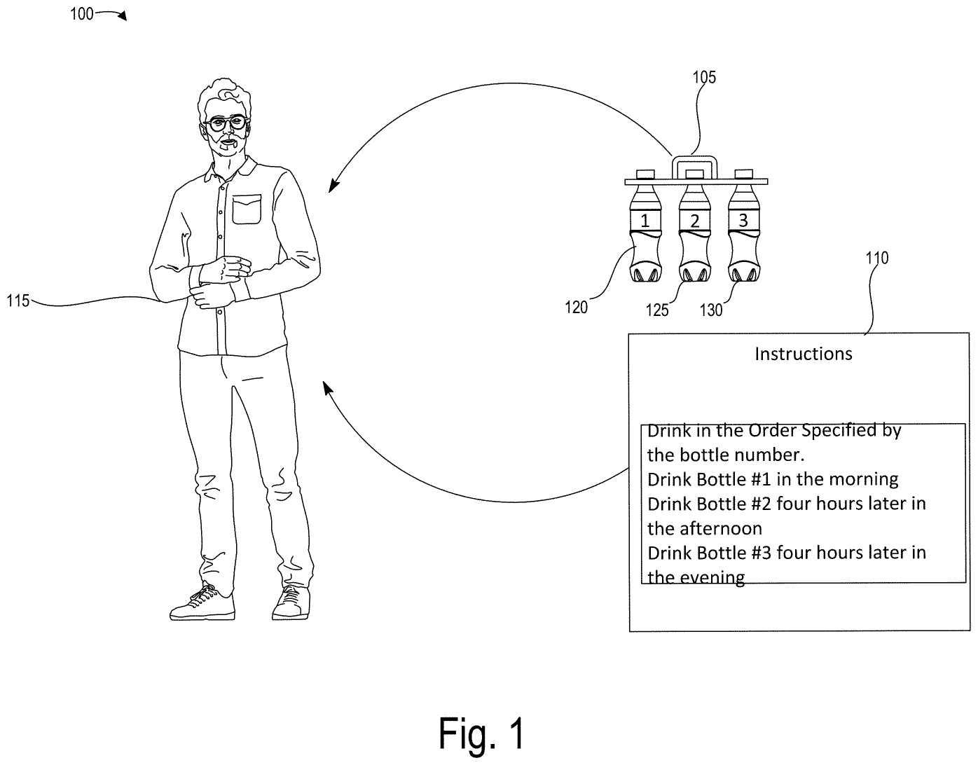

Referring to FIG. 1, FIG. 1 is a flow diagram 100 of an embodiment for a process of delivering micronutrients to an individual 115. The micronutrients may be delivered in the form of nutraceuticals that are suspended in carbonated water. In various embodiments, the nutraceuticals may be extracted from one or more fruits or plants. The nutraceuticals may be packaged into a beverage set 105 that contains two or more beverages. Further instructions 110 may be provided to the individual 115 about which order and about what time to drink the two or more beverages.

The two or more beverages of the beverage set 105 comprise beverages of different compositions of nutraceuticals that compliment the needs of the individual at different times of the day. As shown in FIG. 1, the beverage set 105 may include a first beverage 120, a second beverage 125, and a third beverage 130. The beverage set 105 may include multiple numbers of first beverages 120, second beverages 125, and third beverages 130. An exemplary embodiment comprises six total beverages that include 2 first beverages 120, 2 second beverages 125, and 2 third beverages 130.

The various beverages of the beverage set 105 may be configured to be ingested in a specific order. The instructions may direct the individual 115 to ingest the beverage in an order indicated by a numerical label on each of the beverages. For instance, the first beverage 120 may have a label that includes a number “1” to indicate that the individual should drink the first beverage 120 before the other beverages in the beverage set 105. Similarly, the second beverage 125 may have a label that includes a number “2” and the third beverage 130 may have a label that includes a number “3”.

In various embodiments, the first beverage may include nutraceuticals that stimulate immunity in an individual. The purpose of stimulating immunity for the first beverage 120 is to replenish the nutrients that contribute to an individual's immune response in the morning such that it may last for the day. An exemplary embodiment of the first beverage 120 comprises carbonated water and nutraceuticals from acai berries. In various embodiments, the first beverage comprises carbonated water and nutraceuticals from cherries. An example of the cherries may be ascerola cherries.

In various embodiments, the second beverage 125 may include nutraceuticals that stimulate brain activity in an individual. As the second beverage 125 may be ingested in the afternoon when some individuals have an energy lull, the individual may have an increased need to stimulate brain activity. In various embodiments, nutraceuticals that are configured to perform other functions may be selected. In one example, the second beverage 125 may contain nutraceuticals from yerba mate. In another example, the second beverage 125 may contain nutraceuticals from dragon fruit.

In various embodiments, the third beverage 130 may include nutraceuticals that calm an individual. The third beverage 130 may be ingested in a late part of the day when it would be healthy for an individual to relax. An exemplary embodiment of the third beverage 130 contains hops. An example of the hops in the third beverage 130 may be citrus hops. In various embodiments, the third beverage 130 includes carbonated water and nutraceuticals from grapes.

The instructions 110 may direct the individual 115 to ingest the second beverage 125 only after ingesting the first beverage 120. Alternatively, the instructions 110 may direct the individual to ingest the second beverage 125 at a specific time of day such as at 14:00. The instructions 110 may direct the individual 115 to ingest the two or more beverages of the beverage set 105 in a time interval such as 4 hours apart. Thus, the individual 115 may be instructed to ingest a second beverage 125 4 hours after ingesting the first beverages 120 and to ingest the third beverage 4 hours after ingesting the second beverage 125.

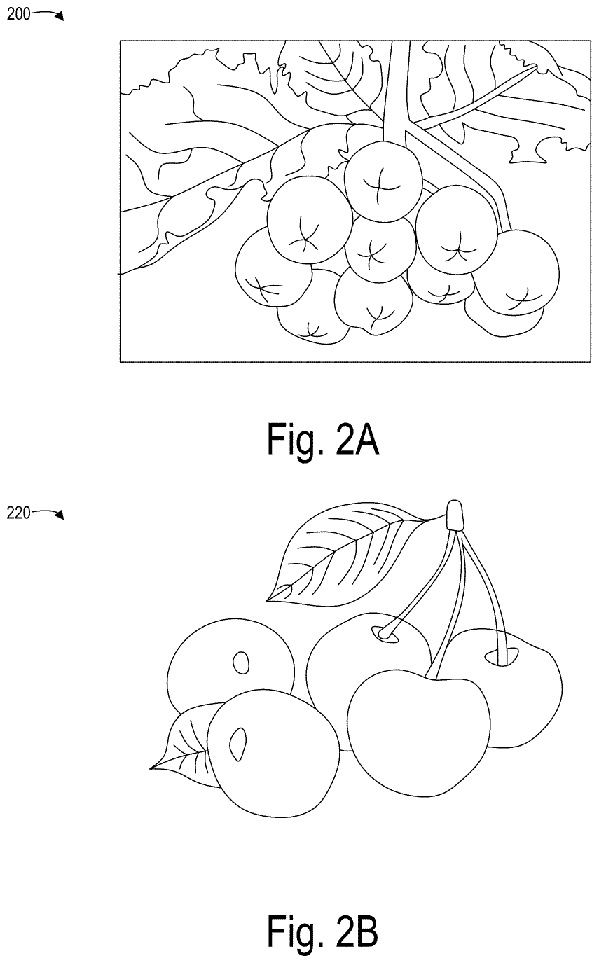

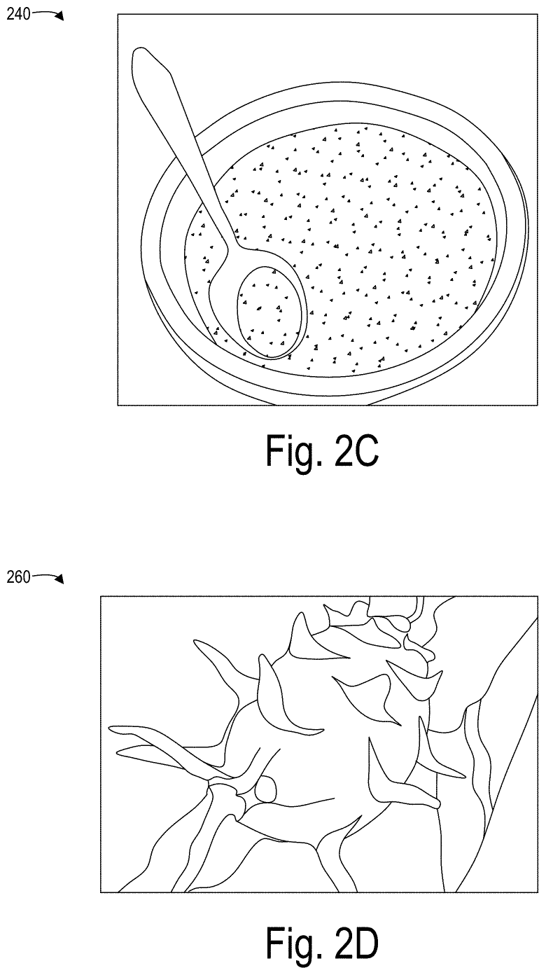

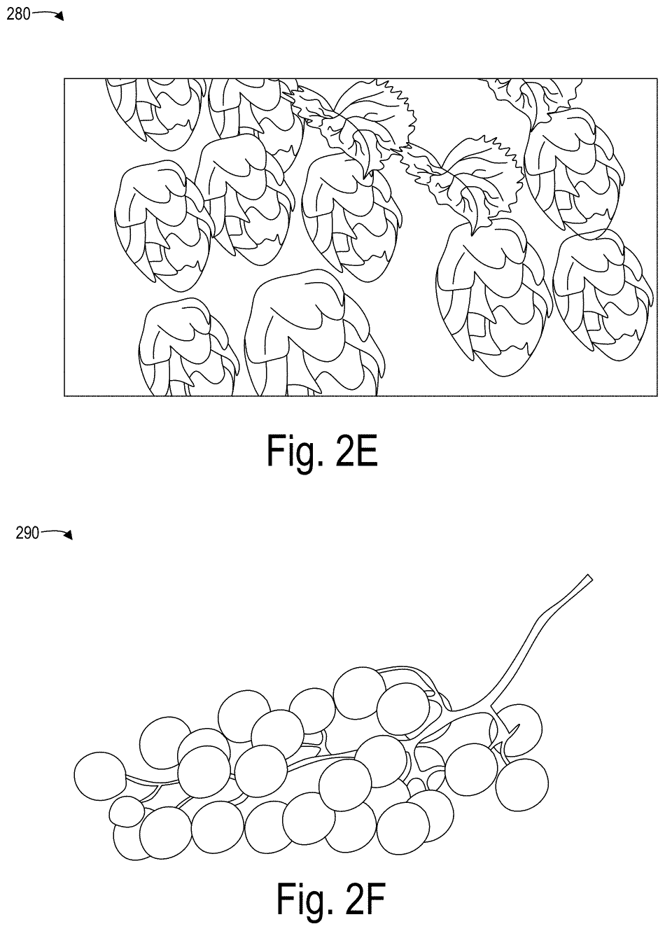

Referring to FIG. 2A, FIG. 2A is an illustration of acai berries 200 that may be incorporated into one or more beverages of the micronutrient delivery system. The term “subset” when used herein may refer to all nutraceuticals in a fruit or plant or a portion of the nutraceuticals in a fruit or plant. A subset of nutraceuticals may contain concentrations of some of the nutraceuticals that approach the similar concentrations of a whole fruit, juice of the whole fruit, whole plant, part of a plant, or plant-based fluid. For example, an embodiment of a first subset of nutraceuticals for the beverage fluid that approaches the similar concentration of the açai fruit are concentrations of a range of between about 2413 μg/g and about 2491 μg/g calcium, a range of between about 1.9 μg/g and about 3.1 μg/g copper, a range of between about 79 μg/g and about 107 μg/g iron, a range of between about 295 μg/g and about 297 μg/g magnesium, a range of between about 1.4 μg/g and about 1.8 μg/g manganese, a range of between about 0.23 μg/g and about 0.29 μg/g molybdenum, and a range of between about 45 μg/g and about 65 μg/g zinc. In an exemplary embodiment, the first subset of nutraceuticals for the beverage fluid may contain concentrations that are less than the concentration of nutraceuticals in the acai fruit. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

The subset of nutraceuticals may be dissolved in a beverage fluid that comprises water. Nutraceuticals may be incorporated into the beverage fluid in various ways. In one example a weight of each nutraceutical is measured in a powdered form to achieve the desired concentration in a volume of water. The one or more nutraceuticals may be added to the beverage fluid in the measured amount.

In another example, a second subset of nutraceuticals that approach the similar nutrient concentrations of the açai fruit include nutraceutical concentrations of about 0.04 mg/g DW cyanidin-3-sambubuiside, about 1.17 mg/g DW cyanidin-3-glucoside, about 1.93 mg/g DW cyanidin 3-rutinoside, about 0.02 mg/g DW peonidin 3-glucoside, and about 0.04 mg/g DW peonidin 3-rutinoside. In an exemplary embodiment, the water with subset of nutraceuticals is carbonated by dissolving carbon dioxide into the water. In an exemplary embodiment, the second subset of nutraceuticals for the beverage fluid may contain concentrations that are less than the similar the similar concentration of nutraceuticals in the acai fruit. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another example of a third subset of açai fruit nutraceuticals, the beverage fluid may include nutraceutical concentrations in a range of between about 71.5 mg/L fresh pulp and about 77.3 mg/L fresh pulp pelargonidin 3-glucoside, a range of between about 217.29 mg/L fresh pulp and about 206.71 mg/L fresh pulp ferulic acid, a range of between about 125.72 mg/L fresh pulp and about 132.28 mg/L fresh pulp (−)-epicatechin, a range of between about 78.5 mg/L fresh pulp and 82.5 mg/L fresh pulp p-hydroxy benzoic acid, a range of between about 62.86 mg/L fresh pulp and about 66.14 mg/L fresh pulp gallic acid, a range of between about 62.76 mg/L fresh pulp and about 66.04 mg/L fresh pulp protocatechuic acid, a range of between about 59.82 mg/L fresh pulp and about 61.78 mg/L fresh pulp (+)-catechin, a range of between about 54.01 mg/L fresh pulp and about 56.79 mg/L fresh pulp ellagic acid, a range of between about 33.2 mg/L fresh pulp and about 31.81 mg/L fresh pulp and about 34.59 mg/L fresh pulp vanillic acid, and a range of between about 15.87 mg/L fresh pulp and about 18.33 mg/L fresh pulp p-coumaric acid. In an exemplary embodiment, the third subset of nutraceuticals for the beverage fluid may contain concentrations that are less than the concentration of nutraceuticals in the acai fruit. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In exemplary embodiments, the beverage fluid may incorporate one or more the disclosed subsets of nutraceuticals of the açai fruit. For example, the beverage fluid may incorporate both the first subset and second subset of the nutraceuticals in concentrations that approximate the concentrations of various nutrients in the açai fruit. In another example, the beverage fluid may incorporate or subtract additional subsets of nutraceuticals in the açai fruit or other fruits or plants.

In yet another embodiment, a fourth subset of acai fruit nutraceuticals may be incorporated into the beverage fluid in concentrations that approximate the concentration of the nutraceuticals in whole açai fruit. The concentrations of the fourth subset of nutraceuticals may be in a range of between about 0.3 mg/100 g DW and about 1.5 mg/100 g DW protocatechuic acid hexoside, a range of between about 1.3 mg/100 g DW and about 2.1 mg/100 g DW protocatechuic acid, a range of between about 5.2 mg/100 g DW and about 16.8 mg/100 g DW vanillic acid, a range of between about 3.7 mg/100 g DW and about 5.9 mg/100 g DW syringic acid, a range of between about 0.3 mg/100 g DW and about 1.1 mg/100 g DW hydroxyferuloyl quinic acid, a range of between about 0.5 mg/100 g DW and about 2.3 mg/100 g DW sinapoyl rhamnose, about 4.5 mg/100 g DW 5-O-caffeoyl quinic acid, a range of between about 0.5 mg/100 g DW and about 1.5 mg/100 g DW p-coumaric acid hexoside, a range of between about 1.1 mg/100 g DW and about 2.7 mg/100 g DW caffeic acid, a range of between about 0.2 mg/100 g DW and about 1.8 mg/100 g DW sinapoyl hexose, a range of between about 8.7 mg/100 g DW and about 21.3 mg/100 g DW orientin, a range of between about 7.2 mg/100 g DW and about 16.8 mg/100 g DW isovitexin, a range of between about 5.0 mg/100 g DW and about 14.8 mg/100 g DW homoorientin, a range of between about 4.6 mg/100 g DW and about 15.0 mg/100 g DW vitexin, a range of between about 0.6 mg/100 g DW and about 1.2 mg/100 g DW luteolin, a range of between about 0.4 mg/100 g DW and about 0.8 mg/100 g DW scoparin, a range of between about 0.2 mg/100 g DW and about 0.8 mg/100 g DW chrysoeriol, a range of between about 0.8 mg/100 g DW and about 1.6 mg/100 g DW taxifolin, a range of between about 2.7 mg/100 g DW and about 4.1 mg/100 g DW rutin, and a range of between about 1.4 mg/100 g DW and about 2.0 mg/100 g DW Isorhamnetin rutinoside. In an exemplary embodiment, the fourth subset of nutraceuticals for the beverage fluid may contain concentrations that are less than the concentration of nutraceuticals in the acai fruit. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In various embodiments, the beverage fluid may contain a substantial portion of nutraceuticals from various fruits or plants other than the açai fruit. For example, the beverage fluid may contain a substantial portion of subsets of nutraceuticals fruits or plants from the group of acerola, dragon fruit, yerba mate, and gak fruit. The beverage fluid may contain various combinations of subsets of the concentrations of nutrients that approximate the concentrations of the nutrients in the whole fruits, plants, or portions thereof.

Referring to FIG. 2B, FIG. 2B is an illustration of cherries 220 that may be incorporated into one or more beverages of the micronutrient delivery system. In an exemplary embodiment, the cherries may comprise acerola. The acerola may be substituted for the acai in the first beverage 120. In an embodiment of the beverage fluid that incorporates nutrients of acerola, the beverage fluid may contain concentrations of a first subset of nutraceuticals of acerola. The first subset may include concentrations of about 767 IU/100 g pulp vitamin A, about 1677.6 mg/100 g pulp vitamin C, about 12 mg/100 g pulp calcium, and about 0.20 mg/100 g pulp iron. In an exemplary embodiment, the first subset of nutraceuticals for the beverage fluid may contain concentrations that are less than the concentration of nutraceuticals in acerola. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another embodiment where the beverage fluid incorporates nutrients from acerola, the beverage fluid may contain a second subset of concentrations of nutraceuticals that approximate the concentrations in acerola. The second subset may comprise nutraceutical concentrations of about 18 mg/100 g pulp magnesium, about 11 mg/100 g pulp phosphorus, about 146 mg/100 g pulp, about 7 mg/100 g pulp sodium, about 0.10 mg/100 g pulp zinc, about 0.086 mg/100 g pulp copper, and about 0.6 μg/100 g pulp selenium. In an exemplary embodiment, the second subset of nutraceuticals for the beverage fluid may contain concentrations that are less than the similar the similar concentration of nutraceuticals in acerola. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another embodiment where the beverage fluid incorporates nutrients from acerola, the beverage fluid may contain a third subset of nutraceuticals that approximate the concentrations in acerola. The third subset may comprise nutraceutical concentrations of about 1677.6 mg/100 g pulp thiamin, about 0.02 mg/100 g pulp riboflavin, about 0.6 mg/100 g pulp niacin, about 0.4 mg/100 g pulp pantothenic acid, about 0.309 mg/100 g pulp vitamin B6, about 0.009 μg/100 g pulp folate, about 14 μg/100 g pulp folic acid, and about 0.130 mg ATE/100 g pulp vitamin E. In an exemplary embodiment, the third subset of nutraceuticals for the beverage fluid may contain concentrations that are less than the concentration of nutraceuticals in acerola. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another embodiment where the beverage fluid incorporates nutrients from acerola, the beverage fluid may contain a subset of nutraceuticals that approximate the nutrients in acerola. The subset for acerola may comprise the nutraceuticals of gallic acid, syringic acid, p-coumaric acid, ferulic acid, caffeic acid, chlorogenic acid, catechin, epicatechin, quercitrin, hypperoside, rutin, kaempferol, kaemperfeol 3-0-rhamnoside, luteolin, dihydrokaempferol 3-o-α-rhamnoside, dihydrokaempferol 3-o-α-rhamnoside, procyanidin b1, aceronidin, cyanidin, cyanidin-3-o-α-rhamnoside, pelargonidin, pelargonidin-3-o-α-rhamnoside, delphinidin, and peonidin.

In yet another embodiment where the beverage fluid incorporates nutrients from acerola, the beverage fluid may contain a fourth subset of nutraceuticals that approximate the concentrations in acerola. The fourth subset of acerola concentrations may include a range of between about 1.0 ug/100 g and about 2.6 ug/100 g neoxanthin plus neochrome, a range of between about 0.1 ug/100 g and about 0.3 ug/100 g violaxanthin, between about 21.1 ug/100 g and about 120.3 ug/100 g lutein, between about 0.1 ug/100 g and about 0.2 ug/100 g zeoxathin, between about 0.1 ug/100 g and about 0.2 ug/100 g 5,6,5′,6′,-diepoxy-β-cryptoxanthin, a range of between about 0.1 ug/100 g and about 0.3 ug/100 g 5,6-epoxy-β-cryptoxanthin, a range of between about 0.4 ug/100 g and about 2.2 ug/100 g cryptoxanthin 5,8-epoxy β-cryptoxanthin, a range of between about 0.1 ug/100 g and about 0.2 ug/100 g zeinoxanthin, a range of between about 12.2 ug/100 g and about 20.4 ug/100 g β-cryptoxanthin, a range of between about 0.7 ug/100 g and about 1.3 ug/100 g 5,6,5′,6′, diepoxy-β-carotene, a range of between about 1.8 ug/100 g and about 4.8 ug/100 g 5,8-epoxy-β-carotene, a range of between about 4.5 ug/100 g and about 11.1 ug/100 g a-carotene, and a range of between about 173.0 ug/100 g and about 358.0 ug/100 g β-carotene. The concentration for neoxanthin plus neochrome in the fourth subset of acerola concentrations is a combined concentration of the two compounds added together. In an exemplary embodiment, the fourth subset of nutraceuticals for the beverage fluid may contain concentrations that are less than the concentration of nutraceuticals in acerola. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

Referring to FIG. 2C, FIG. 2C is an illustration of bowl containing yerba mate 240 that may be incorporated into one or more beverages of the micronutrient delivery system. In an embodiment of the beverage fluid that incorporates concentrations of nutrients of yerba mate, the beverage fluid may contain concentrations of a first subset of nutraceuticals of yerba mate. The first subset may include yerba mate concentrations of about 1112 mg/100 g DW sodium, about 664 mg/100 g DW calcium, about 2227 mg/100 g DW potassium, about 394 mg/100 g DW phosphorus, about 0.2 mg/100 g DW thiamin (B1), between about 0.6 g/100 g DW and about 1.4 g/100 g DW caffeine, about 9.8 g/100 g DW tannin, about 4.4 g/100 g DW alkaloid, and about 0.9 g/100 g DW catechin. In an exemplary embodiment, the first subset of nutraceuticals for the beverage fluid may contain concentrations that are less than the concentration of nutraceuticals in yerba mate. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another embodiment where the beverage fluid incorporates nutrients from yerba mate, the beverage fluid may contain a second subset of concentrations of nutraceuticals that approximate the concentrations in yerba mate. The second subset may comprise yerba mate concentrations of a range of between about 138 mg/100 g DW and about 162 mg/100 g DW calcium, a range of between about 5.9 mg/100 g DW and about 6.9 mg/100 g DW iron, a range of between about 1.0 mg/100 g DW and about 1.2 mg/100 g DW copper, a range of between about 2.0 mg/100 g DW and about 2.6 mg/100 g DW zinc, a range of between about 153 mg/100 g DW and about 183 mg/100 g DW magnesium, a range of between about 0.117 g/100 g DW and about 0.119 g/100 g DW caffeine, and a range of between about 0.0123 g/100 g DW and about 0.0127 g/100 g DW theobromine. In an exemplary embodiment, the second subset of nutraceuticals for the beverage fluid may contain concentrations that are less than the concentration of nutraceuticals in yerba mate. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another embodiment where the beverage fluid incorporates nutrients from yerba mate, the beverage fluid may contain a subset of nutraceuticals that approximate the nutrients, minerals, and other compounds in yerba mate. The subset may comprise yerba mate nutraceuticals of caffeic acid, quinic acid, catechin/epicatechin, ceffeoylshikimic acid, caffeoyl glucose, caffeoylquinic acid, feruloylquinic acid, epicatechin gallate, epigallocatechin gallate, 3 methyl epigallocatechin gallate, dicaffeoylshikimic acid, dicaffeoylquinic acid, and rutin.

Referring to FIG. 2D, FIG. 2D is an illustration of dragon fruit 260 that may be incorporated into one or more beverages of the micronutrient delivery system. In an embodiment of the beverage fluid that incorporates concentrations of nutrients of dragon fruit, the beverage fluid may contain concentrations of a first subset of nutraceuticals of dragon fruit. The first subset may include dragon fruit concentrations of a range of between about 35.49 mg/100 g FW and about 35.77 mg/100 g FW sodium, a range of between about 82.01 μg/100 g FW and about 88.43 μg/100 g FW vitamin A, a range of between about 8 mg/100 g DW and 9 mg/100 g DW vitamin C, and a range of between about 0.29 mg/100 g FW and about 0.31 mg/100 g FW iron. In an exemplary embodiment, the first subset of nutraceuticals for the beverage fluid may contain concentrations that are less than the concentration of nutraceuticals in dragon fruit. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another embodiment where the beverage fluid incorporates nutrients from dragon fruit, the beverage fluid may contain a second subset of concentrations of nutraceuticals that approximate the concentrations in dragon fruit. The second subset may comprise dragon fruit nutraceutical concentrations of about 2.8 mg/100 g pulp niacin, about 38.9 mg/100 g pulp magnesium, 27.5 mg/100 g pulp phosphorus, 272.0 mg/100 g pulp potassium, and 0.35 mg/100 g pulp zinc. In an exemplary embodiment, the second subset of nutraceuticals for the beverage fluid may contain concentrations that are less than the concentration of nutraceuticals in dragon fruit. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

In yet another embodiment where the beverage fluid incorporates nutrients from dragon fruit, the beverage fluid may contain a third subset of concentrations of nutraceuticals that approximate the concentrations in dragon fruit. The third subset may comprise dragon fruit nutraceutical concentrations of about 0.03 μg/g FW β-crypto xanthin, about 0.04 μg/g FW β-carotene, about 0.14 μg/g FW δ-tocopherol, about 0.66 μg/g FW γ-tocopherol, about 2.84 μg/g FW α-tocopherol, about 0.02 μg/g FW δ-tocotrienol, and about 0.02 μg/g FW α-tocotrienol. In an exemplary embodiment, the third subset of nutraceuticals for the beverage fluid may contain concentrations that are less than the concentration of nutraceuticals in dragon fruit. For example, the beverage fluid may contain a range of between about 2% to about 50% the above referenced concentrations of nutraceuticals. In another example, the beverage fluid may contain a range of between about 5% to about 10% the above referenced concentrations of nutraceuticals.

Referring to FIG. 2E. FIG. 2E is an illustration of hops 280 that may be incorporated into one or more beverages of the micronutrient delivery system. Hops may be incorporated into at least one of the two or more beverages to promote a calming effect in the individual. In an exemplary embodiment, the hops may be incorporated into a beverage that is configured to be ingested late in the day when the individual may benefit most from nutraceuticals that induce calm. In various embodiments, the hops 280 may comprise citrus hops.

Referring to FIG. 2F, FIG. 2F is an illustration of grapes 290 that may be incorporated into one or more beverages of the micronutrient delivery system. Like the hops 280, grapes 290 contain nutraceuticals that promote calm in an individual. Accordingly, grapes may be substituted for citrus hops in various embodiments of the micronutrient delivery system. Like hops, a beverage containing a subset of nutraceuticals from grapes may be incorporated into a beverage that is configured to be ingested late in the day.

In various embodiments, nutraceuticals from other plants or fruits that are not shown in FIG. 2A-FIG. 2F may be incorporated into the two or more beverages of the micronutrient delivery system. For example, nutraceuticals from gac fruit may be incorporated into a beverage. In an embodiment of the beverage fluid that incorporates concentrations of nutrients of gac fruit, the beverage fluid may contain concentrations of a first subset of nutraceuticals of gac fruit. The first subset may include gac fruit concentrations of about 71.64 mg/100 g sodium, about 20.72 mg/100 g calcium, about 0.13 mg/100 g iron, about 13.72 mg/100 g magnesium, about 100.78 mg/100 g phosphorus, about 487.40 mg/100 g potassium, about 0.04 mg/100 g copper, about 0.11 mg/100 g zinc, about 3.15 mg/100 g vitamin E, between about 57.42 mg/100 g DW and about 63.24 mg/100 g DW β-carotene, and a range of between about 127.9 mg/100 g DW and about 140.44 mg/100 g DW lycopene. In an exemplary embodiment, the first subset of nutraceuticals for the beverage fluid may contain concentrations that are less than the similar concentration of nutraceuticals in gac fruit. For example, the beverage fluid may contain a range of between about 2% to about 50% of the above referenced concentrations of nutraceuticals. In another example, the beverage fluid may contain a range of between about 5% to about 10% of the above referenced concentrations of nutraceuticals.

In yet another embodiment where the beverage fluid incorporates nutrients from gac fruit, the beverage fluid may contain a second subset of concentrations of nutraceuticals that approximate the concentrations in gac fruit. The second subset may comprise gac fruit concentrations of a range of between about 6.9 ug/g FW and 37.3 ug/g FW β-carotene and a range of between about 0.2 μg/g FW and about 1.6 μg/g FW lycopene. In an exemplary embodiment, the second subset of nutraceuticals for the beverage fluid may contain concentrations that are less than the concentration of nutraceuticals in gac fruit. For example, the beverage fluid may contain a range of between about 2% to about 50% of the above referenced concentrations of nutraceuticals. In another example, the beverage fluid may contain a range of between about 5% to about 10% the above referenced concentrations of nutraceuticals.

In yet another embodiment where the beverage fluid incorporates nutrients from gac fruit, the beverage fluid may contain a third subset of concentrations of nutraceuticals that approximate the concentrations in gac fruit. The third subset may comprise gac fruit concentrations of a range of between about 3.86 mg/g and about 6.08 mg/g gallic acid, a range of between about 14.42 mg/g and about 17.88 mg/g protocatechuic acid, between about 27.59 mg/g and about 30.73 mg/g p-hydroxybenzoic acid, a range of between about 1.66 mg/g and about 2.28 mg/g chlorogenic acid, a range of between about 3.25 mg/g and about 3.57 mg/g caffic acid, a range of between about 4.46 mg/g and about 5.06 mg/g syringic acid, a range of between about 10.8 mg/g and about 12.74 mg/g p-coumaric acid, a range of between about 17.12 mg/g and about 18.98 mg/g ferulic acid, a range of between about 17.13 mg/g and about 18.97 mg/g sinapic acid, a range of between about 171.14 mg/g and about 182.70 mg/g rutin, a range of between about 23.59 mg/g and about 25.85 mg/g myricetin, a range of between about 118.13 mg/g and about 122.83 mg/g luteolin, a range of between about 33.83 mg/g and about 36.17 mg/g quercetin, and a range of between about 18.36 mg/g and about 18.78 mg/g apigenin. In an exemplary embodiment, the third subset of nutraceuticals for the beverage fluid may contain concentrations that are less than the concentration of nutraceuticals in gac fruit. For example, the beverage fluid may contain a range of between about 2% to about 50% of the above referenced concentrations of nutraceuticals. In another example, the beverage fluid may contain a range of between about 5% to about 10% of the above referenced concentrations of nutraceuticals.

The acronym FW used herein refers to the formula weight of a nutraceutical. The acronym DW used herein refers to dry weight. A person skilled in the art in the production of beverages for human consumption will be capable of determining the appropriate amounts of nutraceuticals based on the disclosed concentrations for various volumes of beverage fluids, whether the concentrations be disclosed in weight/weight formula weight, weight/weight dry weight, weight/volume fresh pulp, or weight/weight pulp.

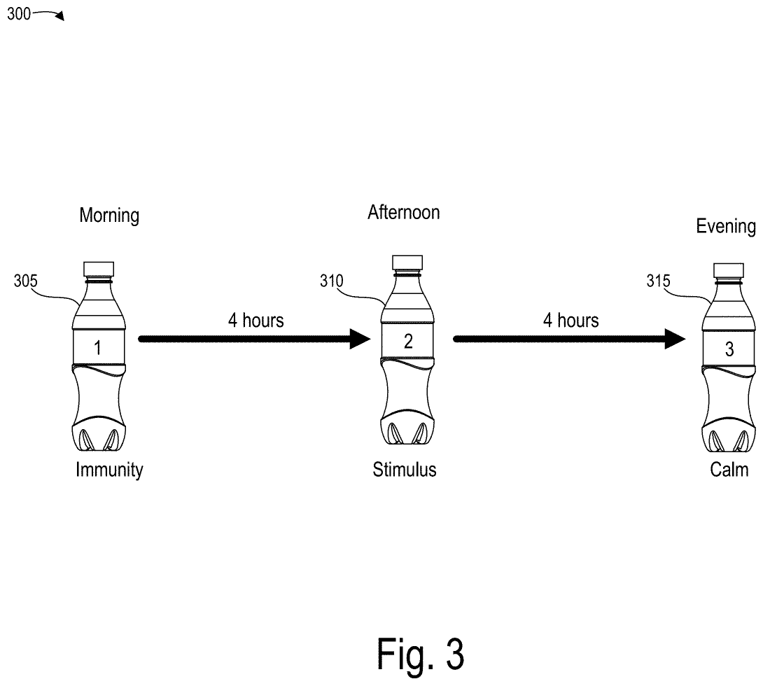

Referring to FIG. 3, FIG. 3 is a schematic of an embodiment of a micronutrient delivery system 300. The micronutrient delivery system 300 comprises a set of three beverages that are configured to be consumed or ingested in a specific order. Further, each of the set of three beverages are configured to be ingested at a specific time relative to one another.

The set of three beverages may comprise a first beverage 305, a second beverage 310, and a third beverage 315. As shown in FIG. 3, a first beverage 305 may be configured to be ingested in the morning. As such, the first beverage 305 may comprise carbonated water that includes nutraceuticals from one or more fruits or plants that stimulate immunity in an individual. In various embodiments, the first beverage 305 includes nutraceuticals from acai fruit or acerola cherries.

The second beverage 310 may be configured to be ingested in the afternoon. In various embodiments, the second beverage 310 may include nutraceuticals from one or more fruits or plants that stimulate brain activity in individuals. For example, the second beverage may include nutraceuticals from yerba mate or dragon fruit.

The third beverage 315 in the beverage set may be configured to calm an individual. As indicated by FIG. 3, the third beverage 315 is last in the series and is configured to be ingested in the evening or otherwise late in the day.

The micronutrient delivery system 300 is not limited to the embodiment shown in FIG. 3 whereby a first beverage 305 is configured to promote immunity, a second beverage is configured to stimulate brain activity, and a third beverage is configured to promote calm in an individual. The micronutrient delivery system 300 may comprise other combinations of nutraceuticals to accomplish various other responses in an individual. For example, a first beverage may contain nutraceuticals that are configured to increase metabolism and a second beverage may contain nutraceuticals that are configured to strengthen skin and bones.

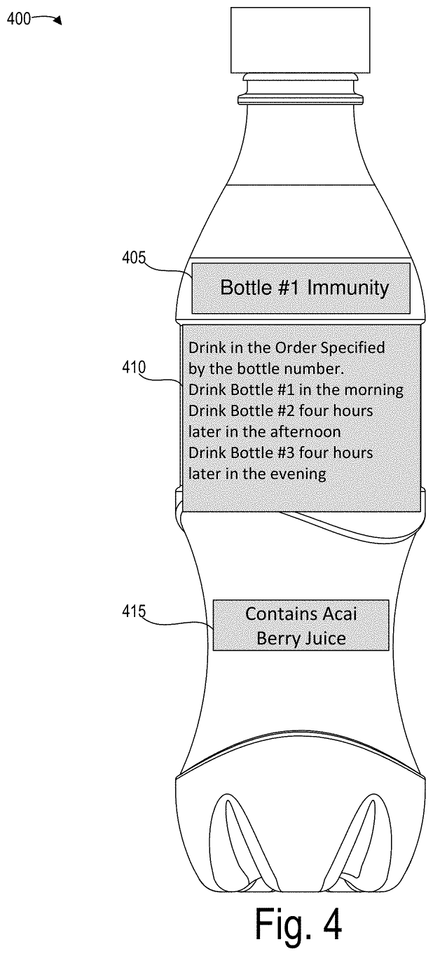

Referring to FIG. 4, FIG. 4 is an illustration of an embodiment of a bottle 400 that may store a single beverage of the micronutrient delivery system 300. The disclosed micronutrient delivery system 300 is not limited to the bottle 400 shown in FIG. 4. In various embodiments, beverages may be stored in other containers including, but not limited to cans, glasses, pouches, and tubes. The two or more beverages may contain different compositions of nutraceuticals such that they are configured to stimulate a different response in the individual. In various embodiments, including the embodiment shown in FIG. 4, each of the two or more beverages includes a label 405 that indicates an order by which the individual should consume or ingest the beverages. For example, the label 405 indicates that the beverage is “Bottle #1 Immunity” and should be consumed before other beverages in the micronutrient delivery system 300. The label 405 also indicates that the bottle 400 contains a nutraceuticals that are configured to stimulate immunity in the individual.

Other bottles in the micronutrient delivery system 300 may indicate a different number to direct the individual to consume them in the order of the number. In various embodiments, the bottle 400 may include a label 410 that directs the individual to consume specific beverages of the micronutrient delivery system 300 at specific times of the day. As specified by the label 410, the individual may be directed to “Drink in the Order Specified by the bottle number”, and to “Drink Bottle #1 in the morning”, then to “Drink Bottle #2 four hours later in the afternoon”, and then to “Drink Bottle #3 four hours later in the evening.” In an exemplary embodiment, the label 410 may further specify a more exact time such as “Drink Bottle #1 at 10:00”, “Drink Bottle #2 at 14:00”, and “Drink Bottle #3 at 18:00.”

A label 415 may further inform the individual of the contents of the bottle 400. As shown in FIG. 4, the label 415 informs the individual that the bottle 400 contains “Acai Berry Juice.” In various embodiments, the label may inform the individual of specific micronutrients in the bottle 400. In an exemplary embodiment, the bottle 400 may contain nutraceuticals from more than one fruit or plant. For example, the label 415 may inform the individual that the beverage contains the following nutraceuticals: 1% Centennial Hop Oil, 1% Eureka! Hop Oil, 1% Nugget Hop Oil, Acerola Juice Concentrate 20 Brix, Beverage Enhancer Natural, Himalayan Pink Salt, Key Lime Flavor Nat Type, Lemon Juice Concentrate, Lime Concentrate 400 GPL (Persian), Lotus Leaf Extract 10:1, Lychee Fl Nat Type, Malic Acid, Mega Red Grape Juice Concentrate, Nat Lime Flavor Extract, Natural Acerola Fl Type, Natural Cherry Fl Type, Natural Dragonfruit Fl Type, Natural Mandarin Flavor Extract, Natural Mango Fl WONF, Natural Passionfruit Fl WONF, Natural Rose Type Fl, Orange Juice Concentrate 64 Brix, Organic Acai Fl WONF, Organic Apple Juice Concentrate 70 Brix, Organic Clarified Acai Juice 2.1 Brix, Organic Lime Juice Concentrate 400 GPL, Organic Raspberry Fl WONF, Organic Red Raspberry Juice Concentrate 65 Brix, Organic Yerba Mate Herbal Tea Extract, Royal Pink Color, Sumatran Pineapple Nectar, and White Grape Juice Concentrate 68 Brix.

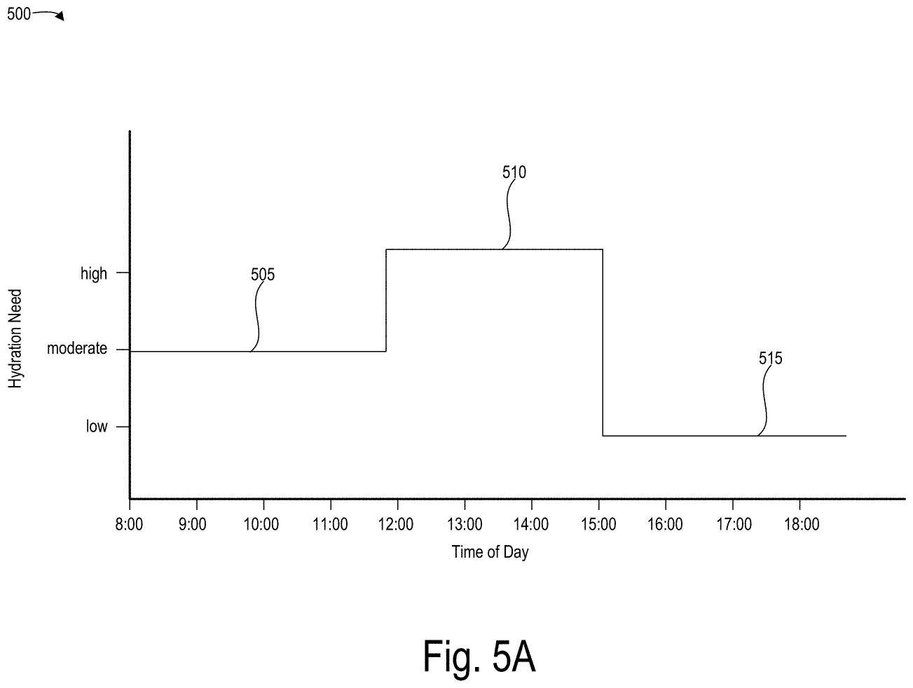

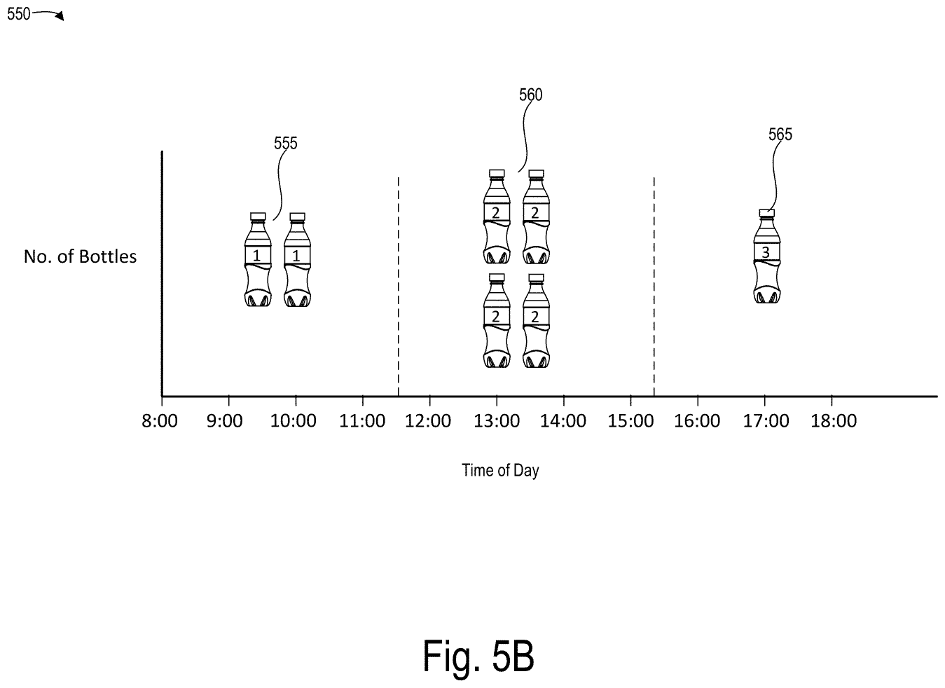

Referring to FIG. 5A, FIG. 5A is a graphic illustration 500 of an example of the hydration need of an individual throughout a daily period. Individuals have different hydration requirements based on variables such as body type, physical activity, and environmental conditions. Their hydration requirements may change throughout the day. For example, an individual may have moderate hydration requirements in the morning 505 period of the day, high hydration requirements in the afternoon 510 period of the day, and low hydration requirements in the evening 515.

Accordingly, the individual may consume a greater volume of the two or more beverages of the micronutrient delivery system 300 at times that the individual requires greater hydration. In various embodiments, the beverage set may be configured to offer varying volumes of the two or more beverages depending on the hydration requirements of the individual. FIG. 5B illustrates how the individual may consume more than 1 of each of the two or more beverages to meet their hydration requirements.

Referring to FIG. 5B, FIG. 5B is a graphic illustration 550 of the number of first beverages, second beverages, and third beverages as they relate to hydration needs of an individual throughout a daily period. The individual may consume one or more first beverages 120, one or more second beverages 125, and one or more third beverages 130 in a daily period. The graphic illustration 550 shows a number of beverages for each of the daily periods that correspond to the hydration needs shown in FIG. 5A.

For instance, an individual with moderate hydration needs in a morning period 555, may consume two first beverages 120 during the morning period 555. And where the individual has high hydration needs in an afternoon period 560, the individual may be directed to consume four second beverages in the afternoon period 560. In an evening period 565, where the individual has low hydration needs, the individual may be directed to consume a single third beverage 130.

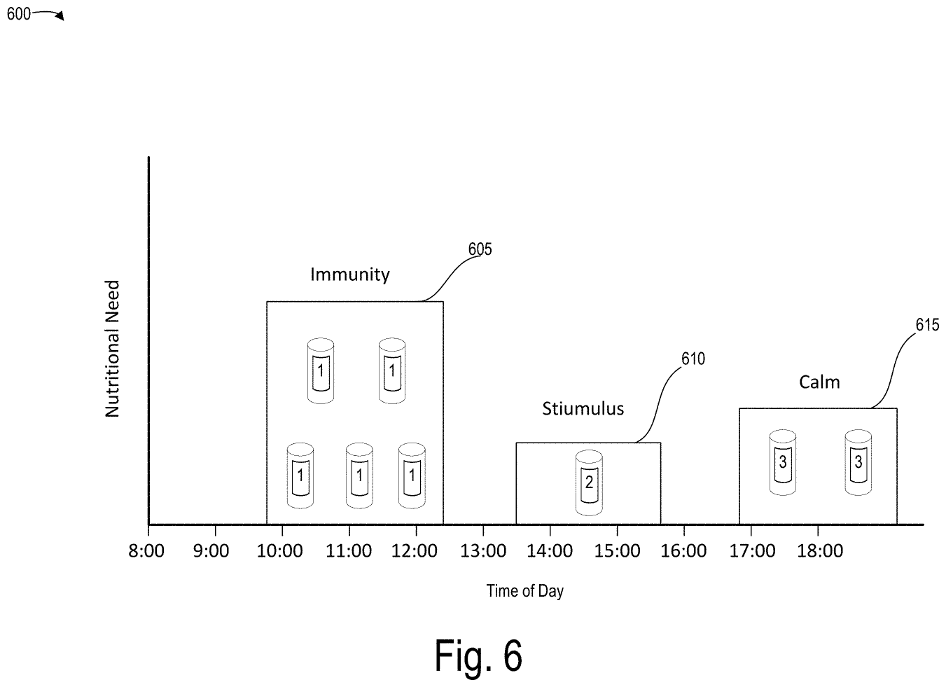

Referring to FIG. 6, FIG. 6 is a graphic illustration of a bar graph 600 of the number of first beverages, second beverages, and third beverages as they relate to nutritional needs of an individual throughout a daily period. As disclosed herein, the disclosed micronutrient delivery system 300 is not limited to storing the two or more beverages in bottles. The embodiment of the micronutrient delivery system 300 shown in FIG. 6 comprises cans that store each of the two or more beverages. An amount of nutraceuticals that are delivered to an individual may be controlled by varying a number of cans of each of the two or more beverages that the individual consumes. For instance, an individual that has a nutritional need for immunity may consume multiple first beverages 605 that are configured to stimulate immunity.

Likewise, the individual may only consume one second beverage 610 that is configured to stimulate that individual when the individual has a marginal need for it. And the individual may consume two third beverages 615 that contain nutraceuticals that are configured to provide a calming effect when the individual has a moderate need for calm.

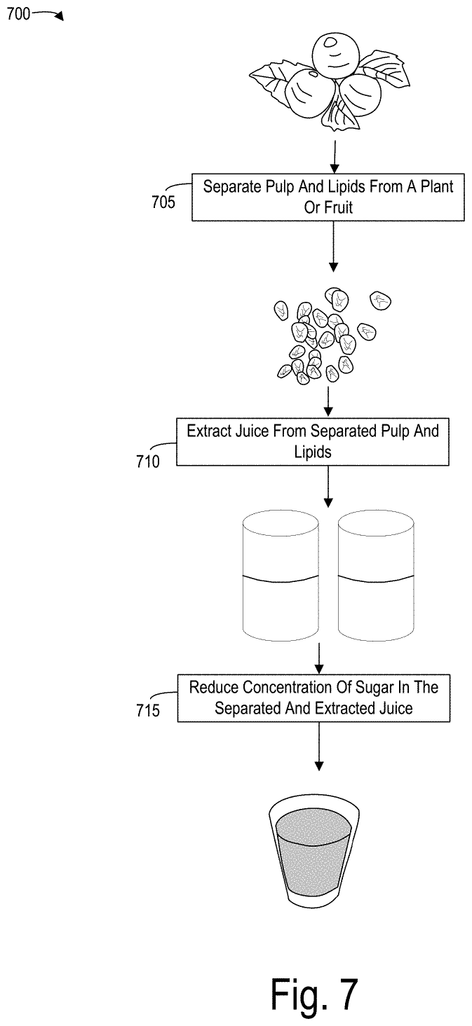

Referring to FIG. 7, FIG. 7 is a flow diagram of an embodiment for a process 700 of the disclosed subject matter for producing a beverage fluid. Multiple variations of the disclosed process 700 may be practiced. At step 705 of the process 700, the process 700 may separate pulp and lipids from a plant or fruit. The separation may be accomplished by various means. In an exemplary embodiment, a fruit is treated by a pulping machine that cores, pulps, separates, and filters a discharge. The pulp and lipids of a fruit or plant or portion thereof may be collected from the discharge.

At step 710 of the process 700, the process 700 may extract juice from the separated pulp and lipids. In an exemplary embodiment, the separated pulp and lipids may be pressed or crushed to break the solids in the pulp and lipids. The broken solution may be separated to yield a solid residue and a juice liquid. In various embodiments, the solid residue of step 710 may be further treated to extract nutraceuticals. For example, the solid residue may be treated with a solvent such as water or ethanol to further extract nutraceuticals from the residue.

At step 715 of the process 700, the process 700 may reduce the concentration of sugar in the separated and extracted juice. In one example of extraction to remove sugars from a juice, the juice may be dried into a cake that contains all compounds of the juice minus water. The cake may then be partially rehydrated, which may substantially leave some of the sugars undissolved in a crystal form in relation to other compounds in the juice, such as the subset of nutraceuticals. In another example, a fruit or plant may be dried. Sugars in the dried fruit or plant may be dissolved in ethanol leaving substantially all of the remaining nutraceuticals of the fruit or plant intact. The resulting juice with reduced sugar concentration may be processed to carbonate the juice. In one example of carbonation, carbon dioxide is bubbled through the sugar-reduced juice at low temperature.

Many variations of the disclosed subject matter may be made to the embodiments described herein. The many variations are intended to be included within the scope of this disclosure. The description of the embodiments herein can be practiced in many ways. The compositions of the various subsets may be combined in additional combinations of nutraceuticals. Any terminology used herein should not be construed as restricting the features or aspects of the disclosed subject matter. The scope should instead be construed in accordance with the appended claims.

1. A micronutrient delivery system, the micronutrient delivery system comprising:
two or more beverages, each of the two or more beverages comprising:
carbonated water; and
nutraceuticals from one or more fruits or plants contained in the carbonated water;
wherein the two or more beverages contain different amounts of nutraceuticals.

2. The micronutrient delivery system of claim 1, wherein the two or more beverages are configured to be ingested in a specific order.

3. The micronutrient delivery system of claim 2, wherein the two or more beverages comprise three beverages.

4. The micronutrient delivery system of claim 3, wherein the three beverages are configured to be ingested in 4 hour intervals.

5. The micronutrient delivery system of claim 4, wherein a first beverage comprises nutraceuticals selected from a group consisting of acai and cherries.

6. The micronutrient delivery system of claim 5, wherein a second beverage comprises nutraceuticals selected from a group consisting of yerba mate and dragon fruit.

7. The micronutrient delivery system of claim 6, wherein a third beverage comprises nutraceuticals selected from a group consisting of hops and grapes.

8. A beverage system, the beverage system comprising:
two or more beverages, each of the two or more beverages comprising:
carbonated water; and
nutraceuticals from one or more fruits or plants contained in the carbonated water;
wherein the two or more beverages contain different amounts of nutraceuticals.

9. The beverage system of claim 8, wherein a total volume of carbonated water of the two or more beverages is sufficient to hydrate an individual over a course of a day.

10. The beverage system of claim 9, wherein each of the two or more beverages comprises instructions to ingest at a different time of day.

11. The beverage system of claim 10, wherein the two or more beverages comprise three beverages.

12. The beverage system of claim 11, wherein the three beverages comprise instructions to be ingested at 4-hour intervals relative to one another.

13. The beverage system of claim 12, wherein a first beverage comprises:
instructions to be ingested at a time of about 10:00; and
nutraceuticals selected from a group consisting of acai and cherries.

14. The beverage system of claim 13, wherein a second beverage comprises:
instructions to be ingested at a time of about 14:00; and
nutraceuticals selected from a group consisting of yerba mate and dragon fruit.

15. The beverage system of claim 14, wherein a third beverage comprises:
instructions to be ingested at a time of about 18:00; and
nutraceuticals selected from a group consisting of hops and grapes.

16. A method for delivering micronutrients to an individual, the method comprising:
transferring two or more beverages to the individual;
wherein each of the two or more beverages comprise:
carbonated water; and
nutraceuticals from one or more fruits or plants contained in the carbonated water;
wherein the two or more beverages contain different amounts of nutraceuticals.

17. The method of claim 16, further comprising instructing the individual to ingest each of the two or more beverages at a different time of day.

18. The method of claim 17, wherein the instructing comprises instructions to ingest the two or more beverages in 4-hour intervals.

19. The method of claim 18, wherein a first beverage comprises nutraceuticals selected from a group consisting of acai and cherries;
wherein a second beverage comprises nutraceuticals selected from a group consisting of yerba mate and dragon fruit; and
wherein a third beverage comprises nutraceuticals selected from a group consisting of hops and grapes.

20. The method of claim 19, wherein a carbonated water volume of each of the beverages is determined based on hydration need of the individual.
